(19) United States
(12) Patent Application Publication
(10) Pub. No.: US 2026/0067811 A1
(43) Pub. Date: Mar. 5, 2026

(54) GROUP SCHEDULING METHOD, USER EQUIPMENT, AND NETWORK DEVICE

(71) Applicant: Beijing Xiaomi Mobile Software Co., Ltd., Beijing (CN)

(72) Inventors: Yanhua LI, Beijing (CN); Xiaowei JIANG, Beijing (CN)

(21) Appl. No.: 19/386,040

(22) Filed: Nov. 11, 2025

Related U.S. Application Data
(63) Continuation of application No. 18/003,292, now Pat. No. 12,495,360.

(51) Int. Cl. H04W 52/02; H04W 72/23; H04W 74/04; H04W 76/28

(52) U.S. Cl. CPC H04W 52/0229; H04W 72/23; H04W 74/04; H04W 76/28

(57) ABSTRACT

A group scheduling method, a user equipment (UE), and a network device. The group scheduling method includes: sending, by the UE, a random access request via a primary cell (PCell) or a secondary cell (SCell); waking up a discontinuous reception (DRX) group by the UE, in a case where the UE receives a contention-free random access response (RAR) message and needs to perform data transmission, where the DRX group includes at least one of the following: a DRX group to which the PCell belongs, or a DRX group to which the SCell belongs.

### CROSS REFERENCE TO RELATED APPLICATION

The present application is a continuation application of U.S. patent application Ser. No. 18/003,292, filed on Dec. 23, 2022, which is a U.S. National Stage of International Application No. PCT/CN2020/098641, filed on Jun. 28, 2020, the entire contents of each of which are incorporated herein by reference for all purposes.

### BACKGROUND

Release 10 (R10) of long-term evolution (LTE) introduces characteristics of carrier aggregation (CA). It may be divided into continuous carrier aggregation and discontinuous carrier aggregation. For the continuous carrier aggregation, a terminal only needs one transceiver to realize multi-carrier communication. For different bands of the discontinuous carrier aggregation, different radio frequency (RF) chains are needed.

### SUMMARY

According to a first aspect of an example of the disclosure, a group scheduling method is provided, which includes:
sending, by a user equipment (UE), a random access request via a primary cell (PCell) or a secondary cell (SCell);
waking up a discontinuous reception (DRX) group by the UE, in a case where the UE receives a contention-free random access response (RAR) message and needs to perform data transmission, where the DRX group includes at least one of the following: a DRX group to which the PCell belongs, or a DRX group to which the SCell belongs.

According to a second aspect of an example of the disclosure, a group scheduling method is provided, which includes:
receiving, by a network device, a random access request, where the random access request is sent by a user equipment (UE) via a primary cell (PCell) or a secondary cell (SCell);
sending, by the network device, a contention-free random access response (RAR) message to the UE, where the UE is configured to wake up a discontinuous reception (DRX) group in a case where the UE receives the contention-free RAR message and needs to perform data transmission, and where the DRX group includes at least one of the following: a DRX group to which the PCell belongs, or a DRX group to which the SCell belongs.

According to a third aspect of an example of the disclosure, a user equipment (UE) is provided. The UE includes: one or more processors; a memory that stores processor-executable instructions; where the processor-executable instructions, when collectively executed by the one or more processors, cause the UE to: send a random access request via a primary cell (PCell) or a secondary cell (SCell); wake up a discontinuous reception (DRX) group, in a case where the UE receives a contention-free random access response (RAR) message and needs to perform data transmission, and where the DRX group includes at least one of the following: a DRX group to which the PCell belongs; or a DRX group to which the SCell belongs.

According to a fourth aspect of an example of the disclosure, a network device is provided. The network device includes: one or more processors; a memory that stores processor-executable instructions, where the processor-executable instructions, when collectively executed by the one or more processors, cause the network device to perform the group scheduling method according to the second aspect of an example of the disclosure.

It is to be understood that the above general descriptions and later detailed descriptions are examples and illustrative, and cannot limit the examples of the disclosure.

### BRIEF DESCRIPTION OF THE DRAWINGS

The accompanying drawings here are incorporated into the specification and constitute a part of the specification, showing the principles consistent with the examples of the disclosure and used together with the specification to explain the examples of the disclosure.

FIG. 1 is a schematic structural diagram of a wireless communication system illustrated according to an example.

FIG. 2 is a schematic flow diagram of a group scheduling method illustrated according to an example.

FIG. 3 is a schematic flow diagram of a group scheduling method illustrated according to an example.

FIG. 4 is a schematic diagram of a composition structure of a group scheduling apparatus illustrated according to an example.

FIG. 5 is a schematic diagram of a composition structure of a group scheduling apparatus illustrated according to an example.

FIG. 6 is a schematic diagram of a composition structure of user equipment illustrated according to an example.

### DETAILED DESCRIPTION

Examples will be described in detail here, and instances are shown in the accompanying drawings. When the following description refers to the accompanying drawings, unless otherwise indicated, the same numbers in different accompanying drawings indicate the same or similar elements. The implementations described in the following examples do not represent all implementations consistent with the examples of the disclosure. Rather, they are merely instances of apparatuses and methods consistent with some aspects of the examples of the disclosure as detailed in the appended claims.

The terms used in the examples of the disclosure are merely for the purpose of describing specific examples, and are not intended to limit the examples of the disclosure. The singular forms “one”, “said”, and “the” used in the examples of the disclosure and the appended claims are also intended to include the multiple forms unless the context clearly indicates other meanings. It also needs to be understood that the term “and/or” used here refers to and includes any or all possible combinations of one or more associated listed items.

It needs to be understood that although the terms first, second, third, etc. may be used to describe various information in the examples of the disclosure, such information should not be limited to these terms. These terms are merely used to distinguish the same type of information from each other. For instance, without departing from the scope of the examples of the disclosure, first information may also be referred to as second information, and similarly, the second information may also be referred to as the first information. Depending on the context, the word “if” as used here can be interpreted as “at the time”, “when”, or “in response to determining”.

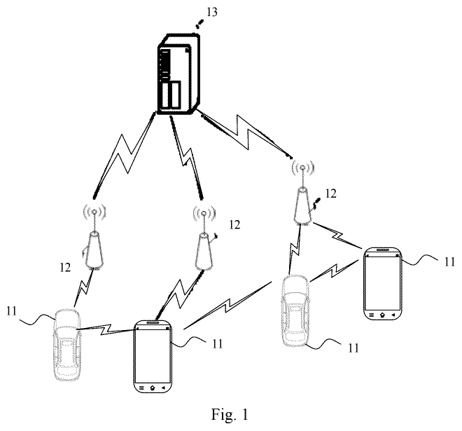

Please refer to FIG. 1, which illustrates a schematic structural diagram of a wireless communication system provided by an example of the disclosure. As shown in FIG. 1, the wireless communication system is a communication system based on cellular mobile communication technology. The wireless communication system may include: a plurality of terminals 11 and a plurality of base stations 12.

The terminals 11 may refer to devices that provide a user with voice and/or data connectivity. The terminals 11 may communicate with one or more core networks via a radio access network (RAN). The terminals 11 may be Internet of Things terminals, such as sensor devices, mobile phones (or called “cellular” phones), and computers with Internet of Things terminals. For instance, the terminals may be fixed, portable, pocket-sized, handheld, computer-built-in, or vehicle-mounted apparatuses. For instance, the terminal may be a station (STA), a subscriber unit, a subscriber station, a mobile station, a mobile, a remote station, an access point, a remote terminal, an access terminal, a user terminal, a user agent, a user device, or user equipment (UE). Or, the terminals 11 may also be unmanned aircraft devices. Or, the terminals 11 may also be vehicle-mounted devices, such as a trip computer with a wireless communication function or a wireless communication device connected to an external trip computer. Or, the terminals 11 may also be roadside devices, such as a street lamp, a signal light, or other roadside devices with wireless communication functions.

The base stations 12 may be network-side devices in the wireless communication system. The wireless communication system may be the 4th generation mobile communication (4G) system, also known as a long-term evolution (LTE) system, or the wireless communication system may also be a 5G system, also known as a new radio (NR) system or a 5G NR system. Or, the wireless communication system may also be a next-generation system of the 5G system. An access network in the 5G system may be called a new generation radio access network (NG-RAN). Or the wireless communication system may be an MTC system.

The base stations 12 may be evolved base stations (eNBs) adopted in the 4G system. Or, the base stations 12 may also be base stations (gNBs) adopting centralized and distributed architectures in the 5G system. When the base stations 12 adopt the centralized and distributed architectures, they typically include a central unit (CU) and at least two distributed units (DU). Protocol stacks of a packet data convergence protocol (PDCP) layer, a radio link control (RLC) layer and a media access control (MAC) layer are disposed in the central unit; and protocol stacks of physical (PHY) layers are disposed in the distributed units, and specific implementations of the base stations 12 are not limited in the example of the disclosure.

The base stations 12 and the terminals 11 may establish a wireless connection through a wireless radio. In different implementations, the wireless radio is a wireless radio based on the 4G standard; or, the wireless radio is a wireless radio based on the 5G standard, such as a new radio; or, the wireless radio may also be a wireless radio based on the next-generation mobile communication standard of 5G.

In some examples, the terminals 11 may also establish an end-to-end (E2E) connection. For instance, vehicle-to-vehicle (V2V) communication, vehicle-to-infrastructure (V2I) communication, and vehicle-to-pedestrian (V2P) communication in vehicle-to-everything (V2X) communication and other scenarios.

In some examples, the above wireless communication system may further include a network management device 13.

The plurality of base stations 12 are connected with the network management device 13. The network management device 13 may be a core network device in the wireless communication system; for instance, the network management device 13 may be a mobility management entity (MME) in an evolved packet core (EPC). Or, the network management device may also be other core network devices, such as a serving gateway (SGW), a public data network gateway (PGW), a policy and charging rules function (PCRF), or a home subscriber server (HSS). The implementation form of the network management device 13 is not limited to the example of the disclosure.

Examples of the disclosure relate to a group scheduling technology, in particular to a group scheduling method and apparatus, user equipment, and a storage medium.

An execution entity involved in the example of the disclosure includes, but is not limited to, user equipment (UE) in a cellular mobile communication system, a base station for cellular mobile communication, and the like.

R10 of long-term evolution (LTE) introduces characteristics of carrier aggregation (CA). It may be divided into continuous carrier aggregation and discontinuous carrier aggregation. For the continuous carrier aggregation, a terminal only needs one transceiver to realize multi-carrier communication. For different bands of the discontinuous carrier aggregation, different radio frequency (RF) chains are needed. It is very likely that a primary cell (PCell) and a secondary cell (SCell) use different RF chains. In this way, the RF chains used by the PCell and the SCell may be controlled respectively, and different discontinuous reception (DRX) groups may be provided with the PCell and the SCell. A CA scenario is different from an original DRX mechanism; that is, an auxiliary DRX group for the SCell is newly introduced. At present, there is no DRX group scheduling technical solution for the CA scenario for reference.

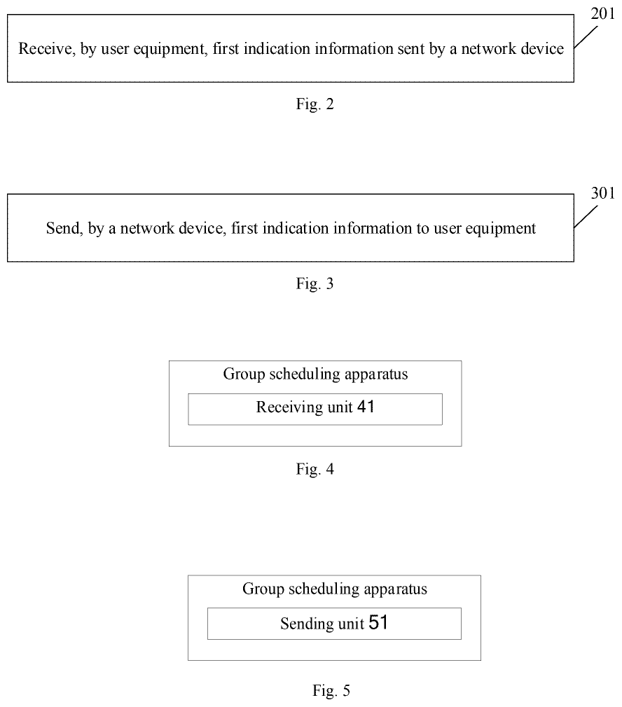

FIG. 2 is a schematic flow diagram of a group scheduling method illustrated according to an example. As shown in FIG. 2, the group scheduling method of the example of the disclosure includes the following step 201.

In step 201, the user equipment receives first indication information sent by a network device, where the first indication information is configured to indicate a DRX group that needs to be woken up by the user equipment due to a trigger of data transmission.

In the example of the disclosure, the DRX group that needs to be woken up by the user equipment due to the trigger of the data transmission includes: a DRX group that needs to be woken up by the user equipment due to the trigger of the data transmission after receiving a contention-free RAR message.

In the example of the disclosure, it is supported that when the user equipment initiates a random access request for a PCell, the DRX group includes a DRX group to which the PCell belongs; it is also supported that when the user equipment initiates the random access request for the PCell, the DRX group includes a DRX group to which an SCell belongs; or when the user equipment initiates the random access request for the primary cell (PCell), the DRX group includes the DRX group to which the PCell belongs and the DRX group to which the SCell belongs. That is, when the user equipment with a DRX function is in a DRX scenario, after the user equipment initiates the random access request through the PCell, it may wake up the DRX group to which the PCell belongs, or the DRX group to which the SCell belongs, or the DRX group to which the PCell belongs and the DRX group to which the SCell belongs when the user equipment needs to perform data transmission after receiving the contention-free RAR message.

In the example of the disclosure, when the user equipment initiates a random access request for an SCell, the DRX group includes a DRX group to which a PCell belongs; or the DRX group includes a DRX group to which the secondary cell (SCell) belongs; or the DRX group includes the DRX group to which the PCell belongs and the DRX group to which the SCell belongs. That is, when the user equipment with a DRX function is in a DRX scenario, after the user equipment initiates the random access request through the SCell, it may wake up the DRX group to which the PCell belongs, or the DRX group to which the SCell belongs, or the DRX group to which the PCell belongs and the DRX group to which the SCell belongs when the user equipment needs to perform data transmission after receiving the contention-free RAR message.

In one example of the disclosure, when the user equipment initiates the random access request for the primary cell (PCell), the DRX group to which the SCell belongs needs to be woken up, or the DRX group to which the PCell belongs and the DRX group to which the SCell belongs need to be woken up; the user equipment needs to support a cross-carrier scheduling function. If the user equipment does not enable the cross-carrier scheduling function, the user equipment needs to be informed to enable the cross-carrier scheduling function. Cross-carrier scheduling information may be configured for the UE in advance, and meanwhile, the network device may further carry a configuration enabling the cross-carrier scheduling function in a message informing the UE for contention-free random access (CFRA) of indication of a DRX group wake-up; or the message informing the UE for CFRA of the indication of the DRX group wake-up may further carry the cross-carrier scheduling information of the UE. Here, the cross-carrier scheduling information of the UE includes carrier frequency information for cross-carrier scheduling, identification information of a to-be-scheduled carrier frequency, and the like.

In the example of the disclosure, receiving, by the user equipment, the first indication information sent by the network device includes: the user equipment receives a radio resource control (RRC) signaling, or a MAC control element or a downlink control information (DCI) message sent by the network device, where the RRC signaling, or the MAC control element, or the DCI message carries the first indication information.

As a means of implementation, the user equipment receives the RRC signaling by monitoring a broadcast channel or a dedicated control channel of the network device.

In the example of the disclosure, the MAC control element carrying the first indication information may further include: it is indicated that the DRX group to which the PCell belongs is woken up, or the DRX group to which the SCell belongs is woken up, or the DRX group to which the PCell belongs and the DRX group to which the SCell belongs are both woken up by a newly added bit in the MAC control element. For instance, 1 bit or 2 bits are newly added in the MAC control element to specifically indicate the DRX group to be woken up. Without considering a resource cost, more bits may also be set to indicate the DRX group to be woken up. As a means of implementation, the MAC control element includes an RAR message.

In the example of the disclosure, the DCI message carrying the first indication information includes: it is indicated that the DRX group to which the PCell belongs is woken up, or the DRX group to which the SCell belongs is woken up, or the DRX group to which the PCell belongs and the DRX group to which the SCell belongs are both woken up by a newly added bit in the DCI message. For instance, 1 bit or 2 bits are newly added to the DCI message to specifically indicate the DRX group to be woken up. Without considering a resource cost, more bits may also be set to indicate the DRX group to be woken up. As a means of implementation, the DCI message includes a msg0 message for random access by the user equipment.

In the example of the disclosure, the RRC signaling, the MAC control element, or the DCI message further carries second indication information, and the second indication information is configured to indicate to the user equipment to enable a cross-carrier scheduling function. That is, the network device may carry information indicating the user equipment to enable cross-carrier scheduling in the RRC signaling, the MAC control element, or the DCI message. Here, after the UE receives the information indicating the user equipment to enable cross-carrier scheduling, and in response to determining that the cross-carrier scheduling function is supported, the cross-carrier scheduling function is enabled. The second indication information may further include carrier frequency information or carrier frequency identification information related to cross-carrier scheduling, and the UE may perform corresponding cross-carrier scheduling based on the carrier frequency information or the carrier frequency identification information.

In the example of the disclosure, when the UE initiates a random access request for an SCell, and the UE does not receive indication information of a DRX group to be woken up in a downlink control message, the method includes: the DRX group to which the PCell belongs is woken up by default in response to determining that an RAR message does not carry an indication of DRX group wake-up, and the user equipment supports and configures with cross-carrier scheduling. Or, the RAR message does not carry the indication of DRX group wake-up, and the user equipment does not support or configure with cross-carrier scheduling, and the DRX group to which the SCell belongs is woken up by default.

According to the technical solution of the example of the disclosure, when the user equipment wakes up a DRX group that needs to be woken up due to a trigger of data transmission after receiving the contention-free RAR message, the user equipment does not wake up the PCell and the SCell indiscriminately, but wakes up only one of the PCell and the SCell or both the PCell and the SCell according to a current data transmission situation. In this way, for the user equipment, there is no need to enable all transceiver antennas in response to a wake-up instruction; and for a DRX group to be woken up, only a transceiver antenna corresponding to the DRX group to be woken up is enabled, such that the user equipment is more power-saving in a DRX mode.

FIG. 3 is a schematic flow diagram of a group scheduling method illustrated according to an example. As shown in FIG. 3, the group scheduling method of the example of the disclosure includes the following step 301.

In step 301, a network device sends the first indication information to the user equipment.

The first indication information is configured to indicate a DRX group that needs to be woken up by the user equipment due to the trigger of data transmission. The DRX group that needs to be woken up by the user equipment due to the trigger of the data transmission includes: a DRX group that needs to be woken up by the user equipment due to the trigger of data transmission after receiving a contention-free RAR message.

In the example of the disclosure, it is supported that when the user equipment initiates a random access request for a PCell, the DRX group includes a DRX group to which the PCell belongs; it is also supported that when the user equipment initiates the random access request for the PCell, the DRX group includes a DRX group to which an SCell belongs; or when the user equipment initiates the random access request for the primary cell (PCell), the DRX group includes the DRX group to which the PCell belongs and the DRX group to which the SCell belongs. That is, when the user equipment with a DRX function is in a DRX scenario, after the user equipment initiates the random access request through the PCell, it may wake up the DRX group to which the PCell belongs, or the DRX group to which the SCell belongs, or the DRX group to which the PCell belongs and the DRX group to which the SCell belongs when the user equipment needs to perform data transmission after receiving the contention-free RAR message.

In the example of the disclosure, when the user equipment initiates a random access request for an SCell, the DRX group includes a DRX group to which a PCell belongs; or the DRX group includes a DRX group to which the secondary cell (SCell) belongs; or the DRX group includes the DRX group to which the PCell belongs and the DRX group to which the SCell belongs. That is, when the user equipment with a DRX function is in a DRX scenario, after the user equipment initiates the random access request through the SCell, it may wake up the DRX group to which the PCell belongs, or the DRX group to which the SCell belongs, or the DRX group to which the PCell belongs and the DRX group to which the SCell belongs when the user equipment needs to perform data transmission after receiving the contention-free RAR message.

In the example of the disclosure, sending, by the network device, the first indication information to the user equipment includes: the network device sends the first indication information to the user equipment through an RRC signaling, a MAC control element, or a downlink control information (DCI) message.

The network device sends the RRC signaling to the user equipment through a broadcast channel or a dedicated control channel.

As an implementation, in the example of the disclosure, sending, by the network device, the first indication information to the user equipment through the MAC control element includes: it is indicated that the DRX group to which the PCell belongs is woken up, or the DRX group to which the SCell belongs is woken up, or the DRX group to which the PCell belongs and the DRX group to which the SCell belongs are both woken up by a newly added bit in the MAC control element. The MAC control element includes an RAR message.

As an implementation, in the example of the disclosure, sending, by the network device, the first indication information to the user equipment through the DCI message includes: it is indicated that the DRX group to which the PCell belongs is woken up, or the DRX group to which the SCell belongs is woken up, or the DRX group to which the PCell belongs and the DRX group to which the SCell belongs are both woken up by a newly added bit in the DCI message. For instance, 1 bit or 2 bits are newly added in the DCI message to specifically indicate the DRX group to be woken up. Without considering a resource cost, more bits may also be set to indicate the DRX group to be woken up. The DCI message includes a msg0 message for random access by the user equipment.

In the example of the disclosure, the method further includes: the network device sending second indication information to the user equipment through the RRC signaling, the MAC control element, or the DCI message, and the second indication information is configured to indicate to the user equipment to enable a cross-carrier scheduling function. That is, the network device may carry information indicating the user equipment to enable cross-carrier scheduling in the RRC signaling, or the MAC control element, or the DCI message. Here, after the UE receives the second indication information, if the cross-carrier scheduling function is supported, the cross-carrier scheduling function is enabled. The second indication information further includes carrier frequency information or carrier frequency identification information related to cross-carrier scheduling, and the UE may perform corresponding cross-carrier scheduling based on the carrier frequency information or the carrier frequency identification information.

According to the technical solution of the example of the disclosure, when the user equipment wakes up a DRX group that needs to be woken up due to the trigger of data transmission after receiving the contention-free RAR message, the user equipment does not wake up the PCell and the SCell indiscriminately, but wakes up only one of the PCell and the SCell or both the PCell and the SCell according to a current data transmission situation. In this way, for the user equipment, there is no need to enable all transceiver antennas in response to a wake-up instruction; and for a DRX group to be woken up, only a transceiver antenna corresponding to the DRX group to be woken up is enabled, such that the user equipment is more power-saving in a DRX mode.

FIG. 4 is a schematic diagram of a composition structure of a group scheduling apparatus illustrated according to an example. As shown in FIG. 4, the group scheduling apparatus of the example of the disclosure is applied to user equipment and includes:

a receiving unit 41 configured to receive first indication information sent by a network device, where the first indication information is configured to indicate a DRX group that needs to be woken up by the user equipment due to the trigger of data transmission.

In one example, the DRX group that needs to be woken up by the user equipment due to the trigger of data transmission includes: a DRX group that needs to be woken up by the user equipment due to the trigger of the data transmission after receiving a contention-free random access response (RAR) message.

In one example, when the user equipment initiates a random access request for a primary cell (PCell), the DRX group includes a DRX group to which the PCell belongs.

In one example, when the user equipment initiates a random access request for a primary cell (PCell), the DRX group includes a DRX group to which a secondary cell (SCell) belongs.

In one example, when the user equipment initiates a random access request for a primary cell (PCell), the DRX group includes a DRX group to which the PCell belongs, and a DRX group to which an SCell belongs.

In one example, when the user equipment initiates a random access request for an SCell, the DRX group includes a DRX group to which the PCell belongs.

In one example, when the user equipment initiates a random access request for an SCell, the DRX group includes a DRX group to which the secondary cell (SCell) belongs.

In one example, when the user equipment initiates a random access request for an SCell, the DRX group includes a DRX group to which the PCell belongs and a DRX group to which the SCell belongs.

In one example, the receiving unit 41 is further configured to receive an RRC signaling, a MAC control element, or a downlink control information (DCI) message sent by the network device, and the RRC signaling, the MAC control element, or the DCI message carries the first indication information.

In one example, the receiving unit 41 is further configured to receive the RRC signaling by monitoring a broadcast channel or a dedicated control channel of the network device.

In one example, the MAC control element carrying the first indication information includes:

it is indicated that the DRX group to which the PCell belongs is woken up, or the DRX group to which the SCell belongs is woken up, or the DRX group to which the PCell belongs and the DRX group to which the SCell belongs are both woken up by a newly added bit in the MAC control element.

In one example, the MAC control element includes an RAR message.

In one example, the DCI message carrying the first indication information includes:
it is indicated that the DRX group to which the PCell belongs is woken up, or the DRX group to which the SCell belongs is woken up, or the DRX group to which the PCell belongs and the DRX group to which the SCell belongs are both woken up by a newly added bit in the DCI message.

In one example, the DCI message includes a msg0 message for random access by the user equipment.

In one example, the RRC signaling, the MAC control element, or the DCI message further carries second indication information, and the second indication information is configured to indicate to the user equipment to enable a cross-carrier scheduling function.

Based on the group scheduling apparatus shown in FIG. 4, the group scheduling apparatus recited in the example of the disclosure further includes:
a wake-up unit (not shown in FIG. 4) configured to wake up the DRX group to which the PCell belongs by default in response to determining that an indication of DRX group wake-up is not carried in an RAR message, and the user equipment supports and configures with cross-carrier scheduling. The wake-up unit is further configured to wake up the DRX group to which the SCell belongs by default in response to determining that an indication of DRX group wake-up is not carried in an RAR message, and the user equipment does not support or configure with cross-carrier scheduling.

In an example, the receiving unit 41, the wake-up unit, etc. may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field-programmable gate arrays (FPGAs), general-purpose processors, controllers, micro controller units (MCUs), microprocessors or other electronic elements, and may also be implemented in combination with one or more radio frequency (RF) antennas to be configured to execute the aforementioned group scheduling apparatus.

In the example of the disclosure, the specific manner in which each module and unit performs operations in the group scheduling apparatus shown in FIG. 4 has been described in detail in the examples of the method, and a detailed description will not be given here.

FIG. 5 is a schematic diagram of a composition structure of a group scheduling apparatus illustrated according to an example. As shown in FIG. 5, the group scheduling apparatus of the example of the disclosure includes:
a sending unit 51 configured to send first indication information to user equipment, where the first indication information is configured to indicate a DRX group that needs to be woken up by the user equipment due to the trigger of data transmission.

In one example, the DRX group that needs to be woken up by the user equipment due to the trigger of the data transmission includes:
a DRX group that needs to be woken up by the user equipment due to the trigger of the data transmission after receiving a contention-free random access response (RAR) message.

In one example, when the user equipment initiates a random access request for a PCell, the DRX group includes a DRX group to which the PCell belongs.

In one example, when the user equipment initiates a random access request for a primary cell (PCell), the DRX group includes a DRX group to which an SCell belongs.

In one example, when the user equipment initiates a random access request for a primary cell (PCell), the DRX group includes a DRX group to which the PCell belongs, and a DRX group to which an SCell belongs.

In one example, when the user equipment initiates a random access request for an SCell, the DRX group includes a DRX group to which the PCell belongs.

In one example, when the user equipment initiates a random access request for the SCell, the DRX group includes a DRX group to which the secondary cell (SCell) belongs.

In one example, when the user equipment initiates a random access request for an SCell, the DRX group includes a DRX group to which the PCell belongs and a DRX group to which the SCell belongs.

In one example, the sending unit 51 is further configured to:
send the first indication information to the user equipment through an RRC signaling, a MAC control element, or a downlink control information (DCI) message.

In one example, the sending unit 51 is further configured to send the RRC signaling to the user equipment through a broadcast channel or a dedicated control channel.

In one example, the sending unit 51 is further configured to:
indicate that the DRX group to which the PCell belongs is woken up, or the DRX group to which the SCell belongs is woken up, or the DRX group to which the PCell belongs and the DRX group to which the SCell belongs are both woken up by a newly added bit in the MAC control element.

In one example, the MAC control element includes an RAR message.

In one example, the sending unit is further configured to:
indicate that the DRX group to which the PCell belongs is woken up, or the DRX group to which the SCell belongs is woken up, or the DRX group to which the PCell belongs and the DRX group to which the SCell belongs are both woken up by a newly added bit in the DCI message.

In one example, the DCI message includes a msg0 message for random access by the user equipment.

In one example, the sending unit 51 is further configured to:
send second indication information to the user equipment through the RRC signaling, the MAC control element, or the DCI message, where the second indication information is configured to indicate to the user equipment to enable a cross-carrier scheduling function.

In an example, the sending unit 51 may be implemented by one or more central processing units (CPUs), graphics processing units (GPUS), baseband processors (BPs), application specific integrated circuits (ASICs), DSPs, programmable logic devices (PLDs), complex programmable logic devices (CPLDs), field-programmable gate arrays (FPGAs), general-purpose processors, controllers, micro controller units (MCUs), microprocessors or other electronic elements, and may also be implemented in combination with one or more radio frequency (RF) antennas to be configured to execute the aforementioned user direct connection communication method.

In the example of the disclosure, the specific manner in which each module and unit performs operations in the group scheduling apparatus shown in FIG. 5 has been described in detail in the examples of the method, and a detailed description will not be given here.

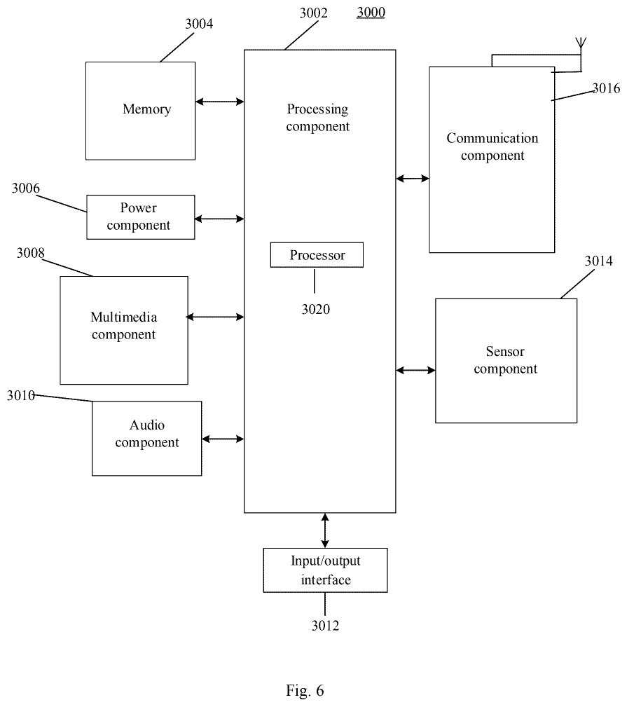

FIG. 6 is a block diagram of user equipment 3000 illustrated according to an example. For instance, the user equipment 3000 may be a mobile phone, a computer, a digital broadcasting terminal, a messaging device, a game console, a tablet device, a medical device, a fitness device, a personal digital assistant, etc.

Referring to FIG. 6, the user equipment 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls the overall operation of the user equipment 3000, such as operations associated with display, a telephone call, data communication, camera operations, and recording operations. The processing component 3002 may include one or more processors 3020 to execute instructions to complete all or part of the steps of the above method. In addition, the processing component 3002 may include one or more modules to facilitate interaction between the processing component 3002 and other components. For instance, the processing component 3002 may include a multimedia module to facilitate interaction between the multimedia component 3008 and the processing component 3002.

The memory 3004 is configured to store various types of data to support operations at the equipment 3000. Instances of these data include instructions for any application or method operating on the user equipment 3000, contact data, phonebook data, messages, pictures, videos, etc. The memory 3004 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or an optical disk.

The power component 3006 provides power for various components of the user equipment 3000. The power component 3006 may include a power management system, one or more power sources, and other components associated with generating, managing, and distributing power for the user equipment 3000.

The multimedia component 3008 includes a screen providing an output interface between the user equipment 3000 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding, and gestures on the touch panel. The touch sensor can not only sense the boundary of the touch or sliding motion, but also detect the duration and pressure related to the touch or sliding operation. In some examples, the multimedia component 3008 includes a front camera and/or a rear camera. When the apparatus 3000 is in an operation mode, such as a shooting mode or a video mode, the front camera and/or the rear camera can receive external multimedia data. Each front camera and rear camera can be a fixed optical lens system or have a focal length and optical zoom capability.

The audio component 3010 is configured to output and/or input audio signals. For instance, the audio component 3010 includes a microphone (MIC) configured to receive an external audio signal when the user equipment 3000 is in the operation mode, such as a call mode, a recording mode, and a speech recognition mode. The received audio signal may be further stored in the memory 3004 or transmitted via the communication component 3016. In some examples, the audio component 3010 further includes a speaker for outputting an audio signal.

The I/O interface 3012 provides an interface between the processing component 3002 and a peripheral interface module, which can be a keyboard, a click wheel, a button, etc. These buttons may include, but are not limited to: a home button, volume buttons, a start button, and a lock button.

The sensor component 3014 includes one or more sensors for providing state evaluation of various aspects of the user equipment 3000. For instance, the sensor component 3014 can detect an on/off state of the equipment 3000 and the relative positioning of the components. For instance, the component is a display and a keypad of the user equipment 3000. The sensor component 3014 can also detect the change of the position of the user equipment 3000 or one component of the user equipment 3000, the presence or absence of user contact with the user equipment 3000, the azimuth or acceleration/deceleration of the user equipment 3000, and the temperature change of the user equipment 3000. The sensor component 3014 may include a proximity sensor configured to detect the presence of nearby objects without any physical contact. The sensor component 3014 may further include an optical sensor, such as a CMOS or CCD image sensor, for use in imaging applications. In some examples, the sensor component 3014 may further include an acceleration sensor, a gyroscope sensor, a magnetic sensor, a pressure sensor, or a temperature sensor.

The communication component 3016 is configured to facilitate wired or wireless communication between the user equipment 3000 and other devices. The user equipment 3000 may access a wireless network based on a communication standard, such as Wi-Fi, 2G, 3G, or their combination. In an example, the communication component 3016 receives a broadcast signal or broadcast-related information from an external broadcast management system via a broadcast channel. In an example, the communication component 3016 further includes a near field communication (NFC) module to facilitate short-range communication. For instance, the NFC module may be implemented based on a radio frequency identification (RFID) technology, an infrared data association (IrDA) technology, an ultra-wideband (UWB) technology, a Bluetooth (BT) technology, and other technologies.

In an example, the user equipment 3000 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements to be configured to execute the above group scheduling method.

In an example, a non-transitory computer-readable storage medium including instructions is further provided, such as the memory 3004 including instructions, which can be executed by the processor 3020 of the user equipment 3000 to complete the above group scheduling method. For instance, the non-transitory computer-readable storage medium may be a ROM, a random access memory (RAM), a CD-ROM, a magnetic tape, a floppy disk, an optical data storage device, etc.

Other implementations of the examples of the disclosure will be apparent to those skilled in the art from consideration of the specification and practice of the disclosure here. The application is intended to cover any variations, uses, or adaptations of the examples of the disclosure following its general principles and including the common general knowledge or frequently used technical means in the technical field not disclosed in the examples of the disclosure. It is intended that the specification and the examples are considered as examples merely, with the true scope and spirit of the examples of the disclosure being indicated by the following claims.

It is to be understood that the examples of the disclosure are not limited to the exact construction that has been described above and illustrated in the accompanying drawings, and that various modifications and changes may be made without departing from its scope. It is intended that the scope of the examples of the disclosure is merely limited by the appended claims.

1. A group scheduling method, comprising:
sending, by a user equipment (UE), a random access request via a primary cell (PCell) or a secondary cell (SCell);
waking up a discontinuous reception (DRX) group by the UE, in a case where the UE receives a contention-free random access response (RAR) message and needs to perform data transmission, wherein the DRX group comprises at least one of the following:
a DRX group to which the PCell belongs; or
a DRX group to which the SCell belongs.

2. The group scheduling method according to claim 1, wherein the group scheduling method further comprises:
receiving, by the UE, first indication information sent by a network device, wherein the first indication information is configured to indicate the DRX group that needs to be woken up.

3. The group scheduling method according to claim 2, wherein receiving, by the UE, the first indication information sent by the network device comprises:
receiving, by the UE, radio resource control (RRC) signaling, a medium access control control element (MAC CE) or a downlink control indicator (DCI) message sent by the network device, wherein the first indication information is carried in the RRC signaling, the MAC CE, or the DCI message.

4. The group scheduling method according to claim 3, wherein receiving, by the UE, the RRC signaling comprises:
monitoring, by the UE, a broadcast channel or a dedicated control channel of the network device.

5. The group scheduling method according to claim 3, wherein the first indication information is carried in the MAC CE by indicating, via a newly added bit in the MAC CE, that at least one of the DRX group to which the PCell belongs needs to be woken up or the DRX group to which the SCell belongs needs to be woken up.

6. The group scheduling method according to claim 5, wherein the MAC CE comprises the contention-free RAR message.

7. The group scheduling method according to claim 3, wherein the first indication information is carried in the DCI message by indicating, via a newly added bit in the DCI message, that at least one of the DRX group to which the PCell belongs needs to be woken up or the DRX group to which the SCell belongs needs to be woken up.

8. The group scheduling method according to claim 3, wherein the DCI message comprises a msg0 message for random access by the UE.

9. The group scheduling method according to claim 3, wherein second indication information is further carried in the RRC signaling, the MAC CE, or the DCI message, and the second indication information is configured to indicate to the UE to enable cross-carrier scheduling.

10. The group scheduling method according to claim 1, wherein the group scheduling method further comprises:
waking up the DRX group to which the PCell belongs by default, in a case where an indication for waking up the DRX group is not carried in the contention-free RAR message, the UE supports cross-carrier scheduling, and the UE is configured with the cross-carrier scheduling.

11. The group scheduling method according to claim 1, wherein the group scheduling method further comprises:
waking up the DRX group to which the SCell belongs by default, in a case where an indication for waking up the DRX group is not carried in the contention-free RAR message, the UE does not support cross-carrier scheduling, and the UE is not configured with the cross-carrier scheduling.

12. The group scheduling method according to claim 1, wherein the UE supports DRX.

13. A group scheduling method, comprising:
receiving, by a network device, a random access request, wherein the random access request is sent by a user equipment (UE) via a primary cell (PCell) or a secondary cell (SCell);
sending, by the network device, a contention-free random access response (RAR) message to the UE, wherein the UE is configured to wake up a discontinuous reception (DRX) group in a case where the UE receives the contention-free RAR message and needs to perform data transmission, and wherein the DRX group comprises at least one of the following:
a DRX group to which the PCell belongs; or
a DRX group to which the SCell belongs.

14. The group scheduling method according to claim 13, wherein the group scheduling method further comprises:
sending, by the network device, first indication information to the UE, wherein the first indication information is configured to indicate the DRX group that needs to be woken up.

15. The group scheduling method according to claim 14, wherein sending, by the network device, the first indication information to the UE comprises:
sending, by the network device, the first indication information to the UE via radio resource control (RRC) signaling, a medium access control control element (MAC CE), or a downlink control indicator (DCI) message.

16. The group scheduling method according to claim 15, wherein sending, by the network device, the first indication information to the UE via the MAC CE comprises:
indicating, via a newly added bit in the MAC CE, that at least one of the DRX group to which the PCell belongs needs to be woken up or the DRX group to which the SCell belongs needs to be woken up.

17. The group scheduling method according to claim 15, wherein sending, by the network device, the first indication information to the UE via the DCI message comprises:
indicating, via a newly added bit in the DCI message, that at least one of the DRX group to which the PCell belongs needs to be woken up or the DRX group to which the SCell belongs needs to be woken up.

18. The group scheduling method according to claim 15, wherein the group scheduling method further comprises:
sending, by the network device via the RRC signaling, the MAC CE, or the DCI message, second indication information to the UE, wherein the second indication information is configured to indicate to the UE to enable cross-carrier scheduling.

19. A user equipment (UE), comprising:
one or more processors;
a memory that stores processor-executable instructions;
wherein the processor-executable instructions, when collectively executed by the one or more processors, cause the UE to:
send a random access request via a primary cell (PCell) or a secondary cell (SCell);
wake up a discontinuous reception (DRX) group, in a case where the UE receives a contention-free random access response (RAR) message and needs to perform data transmission, and wherein the DRX group comprises at least one of the following:
a DRX group to which the PCell belongs; or
a DRX group to which the SCell belongs.

20. A network device, comprising:
one or more processors;
a memory that stores processor-executable instructions;
wherein the processor-executable instructions, when collectively executed by the one or more processors, cause the network device to perform the group scheduling method according to claim 13.
